(19) United States
(12) Patent Application Publication
(10) Pub. No.: US 2005/0033470 A1
(43) Pub. Date: Feb. 10, 2005

(54) System and method for the three-dimensional analysis and reconstruction of the surface of a thin flexible material

(75) Inventors: Jinlian Hu, Hung Hom (HK); Binjie Xin, Hung Hom (HK)

Correspondence Address: LEYDIG VOIT & MAYER, LTD, 700 THIRTEENTH ST. NW, SUITE 300, WASHINGTON, DC, 20005-3960, US

(73) Assignee: The Hong Kong Polytechnic University, Hung Hom (HK)

(21) Appl. No.: 10/927,146

(22) Filed: Aug. 27, 2004

Related U.S. Application Data
(63) Continuation-in-part of application No. 10/829,461, filed on Apr. 22, 2004, now abandoned.
Application No. 10/829,461 is a continuation of application No. 10/162,696, filed on Jun. 6, 2002, now Pat. No. 6,728,593.

(30) Foreign Application Priority Data
Jun. 23, 2004 (CN) 2004/10059785.6

(51) Int. Cl. G06K 9/66; G06K 9/46; G06F 19/00

(52) U.S. Cl. 700/130

(57) ABSTRACT

A system and method for the three-dimensional analysis and reconstruction of the surface of a thin flexible material has a sample holder for supporting the flexible material over a curvature and a camera for capturing profile images of the surface at the curvature. The images are transferred to a computer which is programmed to extract profile height information from the images and produce three-dimensional data representing the surface of the flexible material. The profile height information is extracted by applying a histogram analysis to the images, applying a threshold, and extracting height information.

This application is a continuation-in-part of U.S. application Ser. No. 10/829,461 filed on Apr. 22, 2004; which is a continuation of U.S. application Ser. No. 10/162,696 filed on Jun. 6, 2002. U.S. application Ser. No. 10/162,696 issued on 27 Apr. 2004 as U.S. Pat. No. 6,728,593. Each of the aforementioned applications is included herein by reference.

### BACKGROUND TO THE INVENTION

1. Field of the Invention

The invention relates to a system for the three-dimensional analysis and reconstruction of the surface of a thin flexible material, and in particular to an apparatus and method for constructing a three-dimensional image of a fabric surface.

2. Background Information

When assessing the grade of fabric it is desirable to use objective evaluation criteria so that interested parties can be confident in the represented grading. Recent progress in this area has been directed towards developing automated analysis techniques which are effective in identifying surface characteristics, such as pilling, of fabric. Such automated techniques can provide a standard, objective, evaluation of fabric grade.

Current automated techniques include acquiring surface images from a fabric specimen using a Charge-Coupled Device (CCD) camera with a suitable lighting source. The camera obtains an image of the fabric surface which is manipulated to identify the different reflex intensity (gray) areas created by pilling and background features. A suitable grey threshold is applied to identify pilling on the fabric surface. Such a technique suffers from the disadvantage of the reflectance not being consistent across patterned, colorful or multicolored fabrics. The reflex intensity of the pilled areas appears different in different color areas of the fabric. Thus, on patterned fabric this technique cannot consistently identify fabric surface characteristics.

To avoid the above problem a laser triangulation technique can be used. In this technique the fabric is placed on an X-Y translation table and the high spots on the fabric surface measured one by one with a laser sensor. However, data capture using this technique is considerably slower than with the CCD camera, and because the technique relies on reflection of a laser beam the technique has limitations of use with dark fabrics.

### SUMMARY OF THE INVENTION

It is an object of the present invention to provide a system for the three-dimensional analysis and reconstruction of the surface of a thin flexible material which overcomes or ameliorates the above mentioned disadvantages or which at least provides the public with a useful alternative.

According to the invention there is provided a system for the three-dimensional analysis and reconstruction of the is surface of a thin flexible material comprising:
a sample holder for supporting and bending a thin flexible material over a curvature,
a camera for capturing a plurality of profile images of a surface of the flexible material at the curvature,
a computer in communication with the camera for receiving the profile images, and programmed to extract profile height information of the images and produce three-dimensional data representing the surface of the flexible material. Preferably, extracting profile height information includes the steps of:
analyzing the images to obtain a lateral projection images comprising foreground and background information,
applying a threshold to the lateral projection images to separate the foreground and background information, and
extracting height information of the foreground information.

Preferably, extracting profile height information includes the steps of:
obtaining foreground and background information for the images by finding a Gauss distribution of the images and using a least-squares procedure to obtain a mean and a variance of the Gauss distribution,
applying a threshold to separate the foreground and background information, and
extracting height information from the foreground information.

Preferably, extracting profile height information includes the steps of:
finding a Gauss distribution of the images,
using a least-squares procedure to obtain a mean and a variance of the Gauss distribution,
applying a threshold of the form

$$t = \frac{{u}_{1} + {u}_{2} + λ ( {σ}_{1} - {σ}_{2} )}{2}$$

to obtain threshold data, and
extracting height information from the threshold data.

Preferably, extracting profile height information includes calculating a first and a second coordinate for each point along a profile of the images.

Preferably, extracting profile height information includes:
applying an edge detection algorithm to the images to obtain edge detection data, and
extracting height information from the edge detection data.

Preferably, extracting profile height information includes:
applying an edge detection algorithm to the images to obtain edge detection data, wherein the edge detection algorithm including one of a Marr method, a Sobel operator, a Robert operator, or a Laplace operator, and
extracting height information from the edge detection data.

Preferably, extracting profile height information includes using a radon transform to obtain a gray level distribution of the images in the vertical direction, and extracting height information from the gray level distribution

Further aspects of the invention will become apparent from the following description which is driven by way of example only to illustrate the invention.

### BRIEF DESCRIPTION OF THE DRAWINGS

The invention will now be described with reference to the accompanying drawings in which:

FIG. 1 is a schematic diagram of an apparatus for three-dimensional reconstruction of the surface of a thin flexible material,

FIG. 2 illustrates to embodiments of a sample holder for the apparatus,

FIG. 3 is a schematic diagram of a backlighting device,

FIG. 4 shows steps for operation of the apparatus,

FIG. 5 shows steps for analyzing images captured by the apparatus,

FIG. 6 shows alternative steps for analyzing images captured by the apparatus,

FIG. 7 is an image of a sample test surface,

FIG. 8 is a lateral projection image of the sample after bending,

FIG. 9 is a lateral projection height curve of the sample surface, and

FIG. 10 illustrates a three-dimensional computer reconstruction of the test surface.

### DETAILED DESCRIPTION OF THE INVENTION

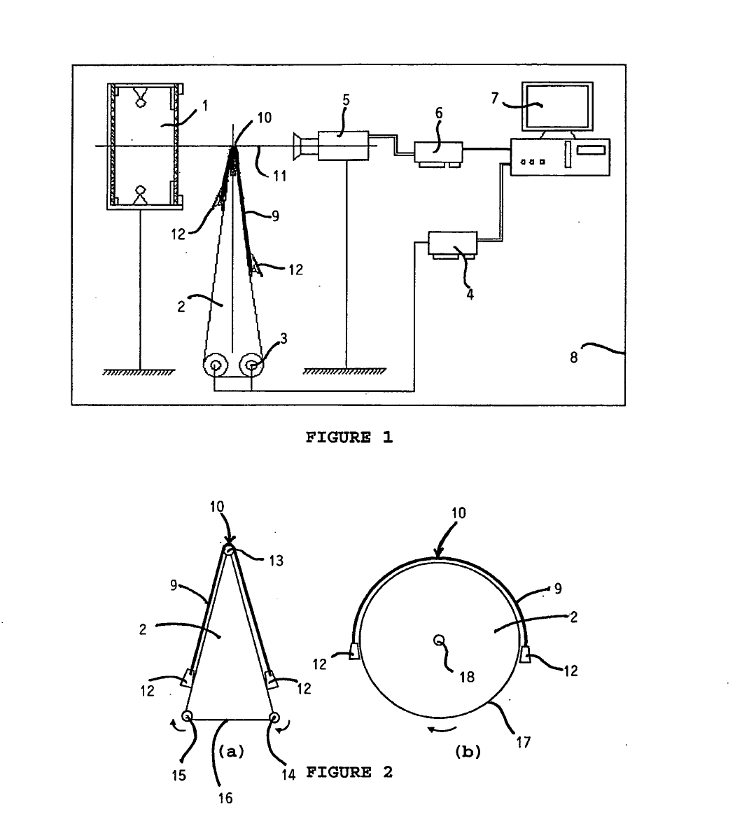

Referring to FIG. 1, apparatus for three-dimensional reconstruction of the surface of a thin flexible material consists of the back lighting source 1, a sample holder 2, a sample drive system 3 and 4, a camera 5 and camera controller 6, and computer 7. The apparatus is enclosed within a light sealed area 8 to shut out natural daylight. The light sealed area 8 may be a dark-room or a specially designed enclosure.

The sample holder 2 is used to support the thin flexible material 9 and bend it to a certain curvature 10 located on an imaginary plain 11 between the lights source 1 and camera 5. Thin flexible materials include, but are not limited to, textiles and fabrics, and printable mediums such as paper or card. An example of a thin flexible material is shown in FIG. 7. The thin flexible material 9 is secured to the sample holder 2 by clips 12.

Referring to FIG. 2, the shape of curvature 10 may be either a sharp A-shape as shown in FIG. 2(a) or a smoother circular O-shape shown in FIG. 2(b). In the Preferred embodiment the sample holder 2 is of the type shown in FIG. 2(a). The sample holder 9 comprises three rollers 13, 14, 15 located at the vertices of an A-shaped frame. An endless belt 13 is positioned about the rollers 13, 14, 15 to support the thin flexible material 9 over the apex vertex 13 to form curvature 10. The base rollers 14, 15 are coupled with drive motor 3 of the drive system.

In the alternative embodiment shown in FIG. 2(b) sample holder 9 comprises a cylindrical frame 17 over which the thin flexible material 9 is supported. The cylindrical frame 17 is rotatably mounted on a shaft 18 which is coupled to drive motor 3 of the drive system.

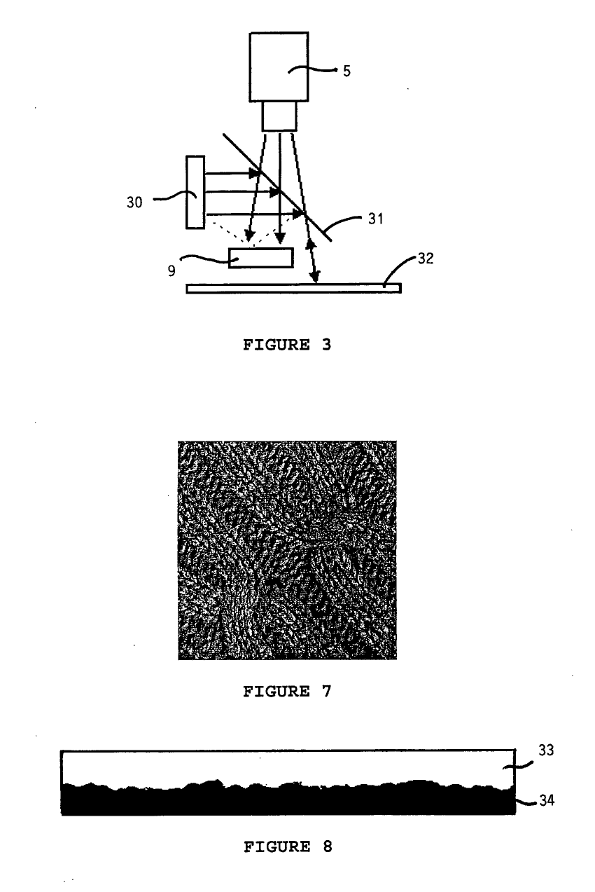

FIG. 3 shows an alternative to the back lighting source 1. In this embodiment an alternative light source 30 is in front of sample 9 perpendicular to the imaging direction of camera 5. A splitter mirror 31 is used to deflect the light on to the sample 9 in the imaging direction. A reflective back plane 32 is located behind the sample 9.

Motor 3 can be a stepper the motor controlled from a step controller 4. Step controller 4 receives position signals from computer 7. The camera 5 is coupled to image capture device 6 which receives image capture signals from computer 7. Computer 7 coordinates the capture of a motion-picture of curvature 10. The drive system 3, 4 moves the sample holder 2 and thus thin flexible material 9 slowly and continuously over curvature 10 as camera 5 is used to capture a motion-picture of curvature 10. Alternatively, the camera is used to capture a plurality of profile images of thin flexible material 9 at curvature 10. The polarity of profile images are obtained by capturing an image of the curvature 10 at each of a plurality of discreet positions obtained by drive system 3, 4.

Computer 7 also performs image processing and analysis techniques to extract the lateral projection height information of the sample surface 9 from each frame of the motion-picture, or the discrete images as the case may be.

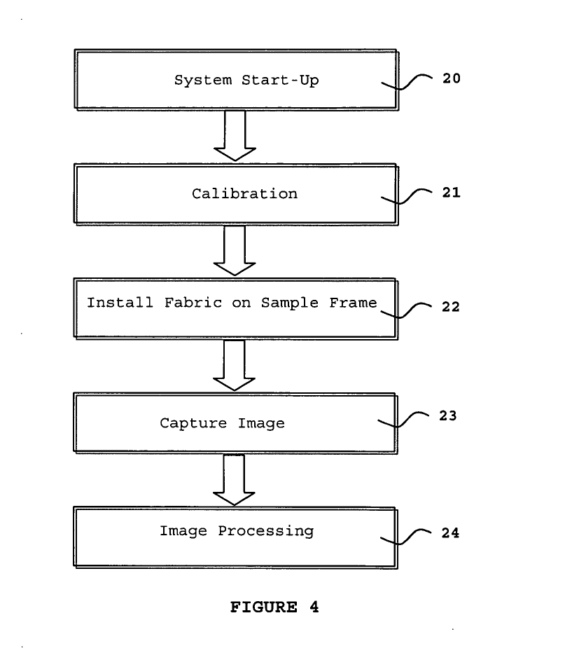

FIG. 4 illustrates the process steps for capture of a motion-picture. Initially, the system is started (20) to power-up the computer, light source, drive system and camera system. After Start-up there is a system calibration step (21) to check the operation of each part of the system. The next step (22) is to install a sample fabric such as that illustrated in FIG. 7 on the sample holder. In an image capture step (23) the drive system 3, 4 moves the sample holder 2 slowly and continuously over curvature 10 as camera 5 is used to capture a motion-picture of curvature 10. The final step (24) is date processing to extract the lateral projection height information of the sample surface from of each of the frames in the motion-picture and reconstruct the three-dimensional surface of the sample.

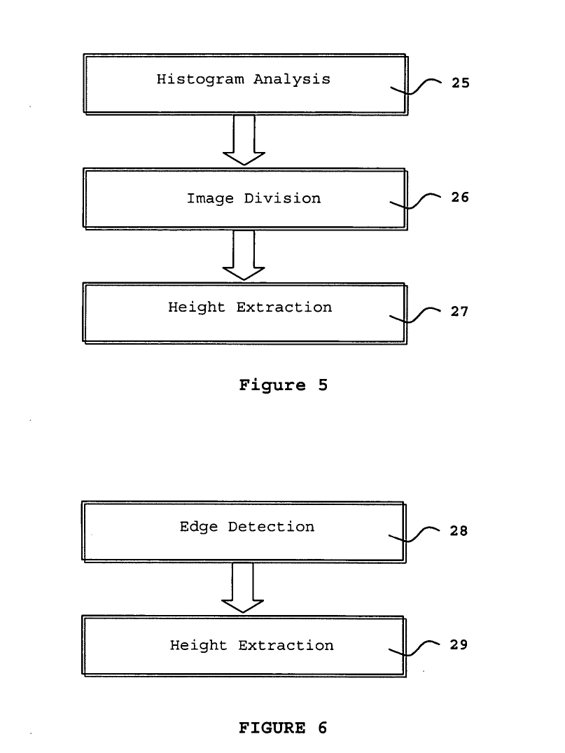

FIG. 5 illustrates the date processing steps in the preferred embodiment of the system.

The first step is a histogram analysis (25). If a lateral projection image of the curved-surface of the sample is f(x.y),f(x.y) ε [0,255], its histogram can be described as h(i),i ε [0,255]. An example of the lateral projection image at curvature 10 is shown on FIG. 8. There are two parts in the image, namely the light background 33 of light source 1 and the dark foreground 34 of fabric sample 9, whose gray level distribution may approximate a Gauss distribution. Using a least-squares procedure the mean and the variance of two distributions: (u₁,σ₁), and (u₂,σ₂) is obtained.

The second step is image division (26). This is achieved by using a threshold to separate the background and foreground of the image. The threshold is defined by

$$t = \frac{{u}_{1} + {u}_{2} + λ ( {σ}_{1} - {σ}_{2} )}{2}$$

where λ is an empirical coefficient. A typical value for λ is 3.

$$The binary processing is f ( x \cdot y ) = \{ \begin{matrix}1 & f ( x \cdot y ) < t \\ 255 & f ( x \cdot y ) > t\end{matrix}$$

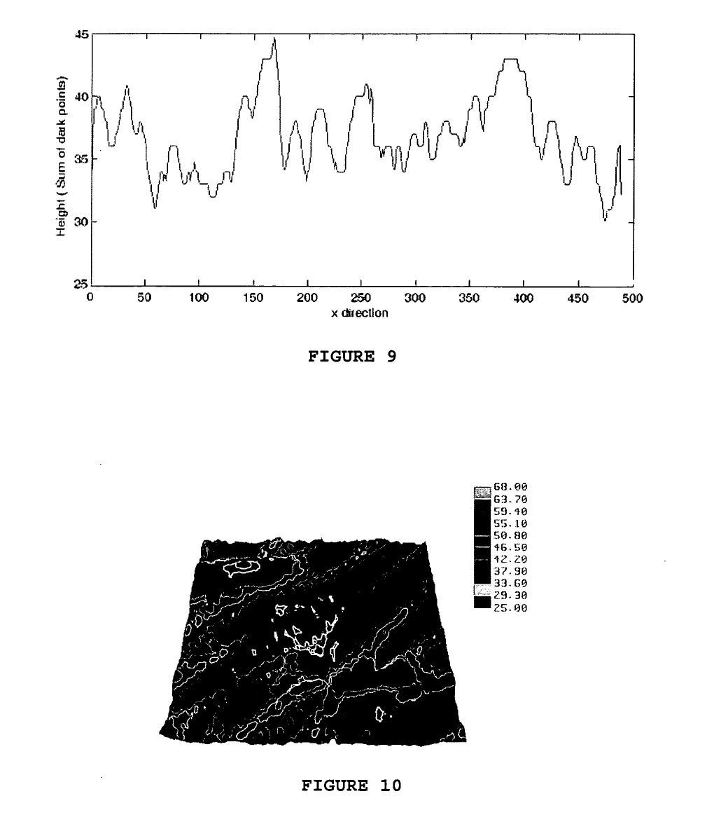

The third step 9 is height extraction (27). This is done by calculating the position (xᵢ,yᵢ) for each point i along the profile of the gray image, where xᵢ, is the horizontal coordinate of each point i and yᵢ is the height coordinate of each point i. Thus, x,y data is obtained for the fabric profile at a plurality of positions along the fabric length. An example of a lateral projection height curve for a sample surface is shown in FIG. 9.

After data process a three-dimensional representation of the fabric surface can be generated. This is done by combining all x,y surface data from the images obtained to produce a three dimensional surface map. Since the fabric sample is running passed the curvature 10 the step size between two successive frames or images is a constant s which can be can calculated from the motor 3 speed. The two-dimensional coordinates system (x,y) of the images is mapped to a three dimensional coordinate system (x,y,z) based of the movement of the fabric sample running past curvature 10. The Z coordinate is obtained from the distance of travel of the fabric sample between frames or images. The first frame captured by the camera 6 is at point z=0 and the next z coordinates are s, 2s, 3s and so on. The three-dimensional surface map of the fabric sample is produced by this sequence of three-dimensional (x,y,z) data. An example of the three-dimensional computer reconstruction is shown in FIG. 10.

Where in the foregoing description reference has been made to integers or elements having known equivalents then such are included as if individually set forth herein.

Embodiments of the invention have been described, however it is understood that variations, improvements or modifications can take place without departure from the scope of the appended claims. For example an alternative method of the date processing step is shown in FIG. 6. This involves edge detection (28) and height extraction (29)

In edge detection (28) commonly algorithm such as the Marr method, Sobel operator, Robert operator, or the Laplace operator are used. In height extraction (29) the image is scanned to determine the coordinates of every point on the detected edge which the coordinates along the vertical edge are the height coordinates.

A further method of the date processing step involves the use of a radon transform. Based on the projection summation (Random Transform in the vertical direction) of the image in the vertical direction the gray level distribution of the image in the vertical direction is obtained. As the gray level is a linear relationship with sample thickness the surface profile height of the sample can be obtained by having it divided by certain proportion factors.

1. A system for the three-dimensional analysis and reconstruction of the surface of a flexible material comprising:
a sample holder for supporting and bending a thin flexible material over a curvature,
a camera for capturing a plurality of profile images of a surface of the flexible material at the curvature,
a computer in communication with the camera for receiving the profile images, and programmed to extract profile height information from the profile images and produce three-dimensional data representing the surface of the flexible material.

2. A method of three-dimensional analysis and reconstruction of the surface of a flexible material comprising:
bending a thin flexible material over a curvature;
capturing a plurality of profile images of a surface of the flexible material at the curvature; and
extracting profile height information from the profile images and producing three-dimensional data representing the surface of the flexible material, wherein extracting profile height information includes
analyzing the profile images to obtain lateral projection images comprising foreground and background information,
applying a threshold to the lateral projection images to separate the foreground and background information, and
extracting height information from the foreground information.

3. A method of three-dimensional analysis and reconstruction of the surface of a flexible material comprising:
bending a thin flexible material over a curvature;
capturing a plurality of profile images of a surface of the flexible material at the curvature; and
extracting profile height information from the profile images and producing three-dimensional data representing the surface of the flexible material, wherein extracting profile height information includes
obtaining foreground and background information for the profile images by finding a Gaussian distribution of the profile images and using a least-squares procedure to obtain mean and variance of the Gaussian distribution,
applying a threshold to separate the foreground and background information, and
extracting height information from the foreground information.

4. A method of three-dimensional analysis and reconstruction of the surface of a flexible material comprising:
bending a thin flexible material over a curvature;
capturing a plurality of profile images of a surface of the flexible material at the curvature; and
extracting profile height information from the profile images and producing three-dimensional data representing the surface of the flexible material, wherein extracting profile height information includes
finding a Gaussian distribution of the profile images,
using a least-squares procedure to obtain mean and variance of the Gaussian distribution,
applying a threshold of the form
$$t = \frac{{u}_{1} + {u}_{2} + λ ( {σ}_{1} - {σ}_{2} )}{2}$$
to obtain threshold data, and
extracting height information from the threshold data.

5. A method of three-dimensional analysis and reconstruction of the surface of a flexible material comprising:
bending a thin flexible material over a curvature;
capturing a plurality of profile images of a surface of the flexible material at the curvature; and
extracting profile height information from the profile images and producing three-dimensional data representing the surface of the flexible material, wherein extracting profile height information includes calculating first and second coordinates for each point along a profile of the profile images.

6. A method of three-dimensional analysis and reconstruction of the surface of a flexible material comprising:
bending a thin flexible material over a curvature;
capturing a plurality of profile images of a surface of the flexible material at the curvature; and
extracting profile height information from the profile images and producing three-dimensional data representing the surface of the flexible material, wherein extracting profile height information includes
applying an edge detection algorithm to the profile images to obtain edge detection data, and
extracting height information from the edge detection data.

7. A method of three-dimensional analysis and reconstruction of the surface of a flexible material comprising:
bending a thin flexible material over a curvature;
capturing a plurality of profile images of a surface of the flexible material at the curvature; and
extracting profile height information from the profile images and producing three-dimensional data representing the surface of the flexible material, wherein extracting profile height information includes
applying an edge detection algorithm to the profile images to obtain edge detection data, wherein the edge detection algorithm includes one of a Marr method, a Sobel operator, a Robert operator, and a Laplace operator, and
extracting height information from the edge detection data.

8. A method of three-dimensional analysis and reconstruction of the surface of a flexible material comprising:
bending a thin flexible material over a curvature;
capturing a plurality of profile images of a surface of the flexible material at the curvature; and
extracting profile height information from the profile images and producing three-dimensional data representing the surface of the flexible material, wherein extracting profile height information includes using a radon transform to obtain a gray level distribution of the profile images in a vertical direction, and extracting height information from the gray level distribution.
